(19) United States
(12) Patent Application Publication
(10) Pub. No.: US 2023/0303221 A1
(43) Pub. Date: Sep. 28, 2023

(54) LAUNCH AND RECOVERY OF UNDERWATER UNITS OR VEHICLES

(71) Applicant: DeepOcean AS, Haugesund (NO)

(72) Inventor: Knut Vibran Knutsen, Haugesund (NO)

(73) Assignee: DeepOcean AS, Haugesund (NO)

(21) Appl. No.: 18/021,077

(22) PCT Filed: Aug. 13, 2021
(86) PCT No.: PCT/NO2021/050176

§ 371 Date: Feb. 13, 2023

(30) Foreign Application Priority Data
Aug. 14, 2020 (NO) 20200901

(51) Int. Cl. B63B 27/14; B63B 27/16

(52) U.S. Cl. CPC B63B 27/143; B63B 27/16; B63B 2027/165; B63B 2035/006; B63B 2205/06; B63B 2205/08

(57) ABSTRACT

A launch and recovery apparatus is for a surface vessel, a surface vessel is for use on water, and related methods are for launching or recovering an underwater unit. The unmanned surface vessel may have a ramp member for providing a ramp structure under the water for facilitating launch or recovery of the underwater unit, the ramp structure having an incline for the underwater unit and an aperture or gap penetrating through the ramp structure for communicating a flow of water in the aperture or gap relative to the vessel. The surface vessel is advanced across the water, obtaining a flow of water relative to the vessel in the aperture or gap through the underwater ramp structure, the underwater unit is supported on the incline of the ramp structure, and the underwater unit is moved up or down the incline to facilitate the launch or recovery of the underwater unit.

### TECHNICAL FIELD

The present invention relates to the launch and recovery of underwater units, e.g. underwater vehicles, and in particular, it relates to launch and recovery apparatus for surface vessels, a surface vessel, e.g. an unmanned surface vessel (USV), and methods of launching or recovering an underwater unit, e.g. an ROV.

### BACKGROUND

In offshore operations, deployment of an underwater vehicle or other underwater unit may be carried out from a surface vessel. The surface vessel, e.g. ship or boat, can travel to the desired location with the underwater vehicle or unit onboard. The underwater vehicle or unit can then be deployed into the water. The underwater vehicle, such as a remotely operated vehicle (ROV) can be deployed to perform various underwater operations, e.g. inspection, survey, or work operations. After use, the underwater vehicle is brought back onboard the surface vessel.

An ROV is connected by an umbilical to the surface vessel. ROV services, e.g. power, data communication, and/or fluid services, are provided through the umbilical, and the ROV is operated typically by operator personnel “pilots” on the surface vessel. Another type includes autonomous underwater vehicles (AUVs) which operate self-sufficiently once deployed and autonomously without any umbilical connection or human control.

The motion of the surface vessel due to sea conditions presents challenges for the deployment of underwater vehicles from surface vessels. Thus, an underwater vehicle may only be deployable when weather and sea conditions permits, e.g. when sufficiently calm. In calm conditions, deployment apparatus on the vessel may be provided without being subjected to significant motion forces that may destabilize or damage the vehicle and/or vessel during launch or recovery from the surface vessel and/or may impose risks of harm to personnel.

In launch or recovery operations where the underwater vehicle is connected to cables payed out from a device on the surface vessel, motions of the vessel may be transmitted to the underwater vehicle and cause variations in load on the cable that can potentially lead the cable to snap. Similarly, motions of the sea may be transmitted to the vessel or other deployment apparatus hampering launch and recovery and potentially causing damage to the underwater vehicle and the deployment apparatus or equipment on the vessel. Existing solutions to address this include motion compensation, e.g. damping devices, but the provision of such devices can increase complexity and such devices can be large and cumbersome, which in their own right may comprise bodies that are in put movement (for compensation purposes) due to the sea with the associated risks that that can provide.

Furthermore, the inventors herein have seen a need for addressing issues of sea state particularly for launch and recovery of underwater vehicles or units from small (e.g. < 50 m) unmanned surface vessels (USV) for providing a launch and recovery system that is sufficiently predictable, reliable and robust under automated control.

### SUMMARY OF THE INVENTION

According to a first aspect of the invention, there is provided an unmanned surface vessel for use on water, the unmanned surface vessel having at least one ramp member for providing a ramp structure under the water for facilitating launch or recovery of an underwater unit, the underwater ramp structure comprising an incline for moving the underwater unit up or down the incline and at least one aperture or gap penetrating through the ramp structure for communicating a flow of water in the aperture or gap relative to the vessel.

The vessel may be advance across the water in a forward direction, and the water may pass and/or be urged through the aperture or gap of the ramp structure in a rearward direction relative to the vessel. Alternatively, the vessel may be advanced in a rearward direction, and the water may pass and/or be urged through the aperture or gap of the submerged and inclined ramp member in a forward direction relative to the vessel.

The ramp member may be lowerable or otherwise movable into an operational position in which the ramp member is arranged in use to provide the underwater ramp structure. The ramp member may be movable between a stowed position and the operational position. The ramp member may be raised or otherwise movable out of the operational position toward the stowed position. In the stowed position, the ramp member may be advantageously arranged for transit of the vessel, e.g. once the underwater vehicle has been launched or retrieved. The ramp member may be lowered into the water to provide the underwater ramp structure. The ramp member may be raised out of the water from the operational position, and may be stored out of the water in the stowed position.

The unmanned vessel may comprise a hull. The ramp member may be supported from a hull of the vessel. The ramp member may be movably coupled to the hull for moving or deploying the ramp member into the operational position. The vessel may comprise one or more actuators which may be operable for moving or deploying the ramp member into the operational position.

The ramp member may typically be hinged about a pivot on the hull so as to be lowerable to the operational position. The pivot may be disposed at or near a rear end of the hull.

In other examples, the ramp member may be slid, rolled, and/or rotated relative to the hull to obtain the operational position. The ramp member may be slid or rolled along a track on the hull to obtain the operational position. The ramp member may be extractable from the hull, e.g. between a retracted position and an extended position in which the ramp member may obtain the operational position. In the retracted position, the ramp member may be enveloped by or brought inboard of the hull. In the extended position, the ramp member may be arranged to extend outboard of the hull. The ramp member may be lifted or manipulated into place, e.g. using one or more actuators, to be supported upon the vessel or hull in the operational position.

The vessel may comprise support means for supporting the ramp member in the operational position, e.g. on the hull. The support means may include one or more actuators, e.g. the one or more actuators above, e.g. which may operate for moving or deploying the ramp member into the operational position. The vessel and/or hull may comprise a coupling between the ramp member and the hull for retaining and supporting the ramp member in the operational position and/or for supporting and retaining the ramp member relative to the hull and/or supporting part(s) of the vessel during movement toward the operational position. The coupling may comprise mechanically engaging parts which may cooperate to hinder and/or restrict dislodgement and/or to retain the ramp member in position on the vessel, e.g. relative to the hull upon moving and using the ramp member for the launch and recovery operation. The parts which cooperate may comprise at least one supporting part of the vessel or hull and at least one cooperating part of the ramp member.

The ramp member, in the operational position, may be further arranged to extend from the rear end of the hull and/or the pivot to a depth underwater that is lower than an underside or keel of the hull.

The ramp member may be configured to be arranged to extend outboard of a rear end of a hull of the vessel.

The unmanned surface vessel may comprise a plurality of ramp members which together may provide the underwater ramp structure. Individual ramp members of the plurality may be lowered independently into the water to provide the ramp structure, e.g. a starboard ramp member may be first lowered, then a port ramp member may be lowered. Together the starboard ramp member and the port ramp member may define the gap laterally therebetween. Furthermore, the plurality may comprise at least one pair of ramp members, one movably coupled to the other. To deploy the pair of ramp members to provide the ramp structure in the water, the one ramp member of the pair may be moved, e.g. by sliding, translation, or rotation, e.g. hinging, relative to the other ramp member of the pair. The pair may further be lowerable together to position the pair in the water in the operational position for providing the ramp structure. The one ramp member of the pair may be positioned further outboard from the hull or supporting part of the vessel than the other ramp member of the pair.

The unmanned surface vessel may further comprise at least one sloped deck section. The ramp member together with the sloped deck section may provide a slipway for the underwater unit.

The unmanned surface vessel may further comprise launch and recovery apparatus comprising any one or more of: the ramp member; a winch; a tether extending between the winch and the underwater unit; and a sheave through which the tether is passed between the winch and the underwater unit, the sheave arranged to be moved forward or rearward along the vessel for positioning the sheave relative to the ramp member and/or the underwater unit. The launch and recovery apparatus may further comprise at least one actuator for lowering or raising the ramp member.

The underwater unit is typically an underwater vehicle. The underwater vehicle is for example a remotely operated underwater vehicle, ROV, or an autonomous underwater vehicle, AUV. The tether, in the example of the underwater vehicle being an ROV, may comprise an umbilical cable.

According to a second aspect of the invention, there is provided a method of launching or recovering an underwater unit from an unmanned surface vessel, the method comprising the steps of: providing an unmanned surface vessel according to the first aspect of the invention on the water, whereby the ramp structure is provided under the water; advancing the vessel across the water, obtaining a flow of water relative to the vessel in the aperture or gap through the underwater ramp structure; supporting the underwater unit on the incline of the ramp structure, moving the underwater unit up or down the incline to facilitate in the launch or recovery of the underwater unit.

The method may include using water passing rearward relative to the hull to impart a component of force against the underwater unit on the ramp member, through the aperture or gap of the inclined ramp member.

Typically, the ramp member is hinged, and the method may include lowering the ramp member about a pivot on a hull of the surface vessel to submerge and incline the ramp member in the water.

The method may further comprise providing launch and recovery apparatus including: at least one winch provided with at least one tether extending between the winch and the underwater unit; at least one sheave through which the tether passes and which is movably positioned rearward or forward along the vessel relative to the ramp member; at least one actuator to lower the ramp to incline and submerge the ramp portion in the water. The method may further comprise operating the launch and recovery apparatus to determine or control tension of the tether.

Operating the launch and recovery apparatus to determine or control tension of the tether may include positioning the sheave to determine an angle of attack between the underwater unit and the sheave and/or positioning the ramp using the actuator to determine an angle of incline of the ramp.

The method may further comprise pulling the underwater unit up the ramp to bring the underwater unit on board the unmanned surface vessel to recover the underwater unit, or letting the underwater unit travel down the ramp to let the underwater unit into the water to launch the underwater unit.

According to a third aspect of the invention, there is provided a ramp member for an unmanned surface vessel according to the first aspect of the invention.

The ramp member may comprise a structure comprising at least one aperture or gap penetrating therethrough.

The structure may comprise a frame which may comprise at least one adjacent pair of parallel bar sections extending in a first direction, and at least one aperture between the one bar of the pair and the other. The structure may comprise a frame which may comprise at least one adjacent pair of parallel bars extending in a second direction that is transverse to the first direction, and having at least one aperture between the one bar of the pair and the other.

The ramp member or a structure thereof may comprise a panel. The aperture may comprise one or more holes through the panel.

The ramp member may be or may comprise a structure that is rigid and/or stiff. This may facilitate avoiding flexure of the ramp member in response to wave or surface motions or drag, and further may facilitate that the ramp member and apertures maintain configuration in use when submerged in the water. This in turn, may facilitate better control, e.g. of tension on the tether in such examples, as the configuration and amount of drag and lift provided through the ramp member may be maintained. Thus, the ramp member may comprise or consist essentially of rigid structural components. The ramp member, e.g. the frame, bars and/or panel may comprise or consist essentially of any one or more of: metal, rigid plastics material, rigid fibre material, e.g. carbon fibre, and/or composites thereof. The ramp member may be non-buoyant in water.

The ramp member may further comprise at least one hinge connector part for coupling to at least one connector part on a hull of the vessel for providing hinged coupling therebetween.

According to a fourth aspect of the invention, there is provided launch and recovery apparatus for a surface vessel on water, the apparatus comprising at least one ramp member for providing a ramp structure under the water for facilitating launch or recovery of an underwater unit from the surface vessel, the underwater ramp structure comprising an incline for the underwater unit and at least one aperture or gap penetrating through the ramp structure for communicating a flow of water in the aperture or gap relative to the vessel. The ramp member may be a ramp member according to the third aspect of the invention.

The ramp member may be configured to be supported by or coupled to a hull of the surface vessel. The ramp member may be a lowerable ramp member. The apparatus may further comprise at least one actuator for lowering the ramp member into the water for operation. The ramp member may be a hinged ramp member arranged to be hinged about a pivot supported on a hull of the vessel.

The surface vessel and/or the launch and recovery apparatus may include positioner means for positioning the underwater unit onboard the vessel. The positioner means may be arranged and/or operable to engage the underwater unit for imparting a force to the underwater unit. The imparted force may: facilitate the launch or recovery of the underwater unit from the vessel; facilitate movement of the unit out of the storage region; urge the underwater unit down slope; and/or impart, produce and/or maintain tension on the tether which may extend between the underwater unit and the surface vessel and/or the winch. The launch and recovery apparatus may be remote operable and/or operable through preprogrammed instruction. It may be controlled and/or activated and/or operated over wireless communication from shore.

According to a fifth aspect of the invention, there is provided a surface vessel for use on water, the vessel comprising a hull and at least one ramp member, the ramp member being movably supported on the hull so as to be lowerable to an operational position wherein the ramp member is arranged to provide a ramp structure under the water in use for facilitating launch or recovery of an underwater unit, the underwater ramp structure comprising an incline for the underwater unit and at least one aperture or gap penetrating through the ramp structure for communicating a flow of water in the aperture or gap relative to the vessel.

The ramp member may be coupled through a hinge and/or pivot to the hull. The ramp member may thus be hinged about the pivot. The pivot may be disposed at or near a rear end of the hull. The pivot may comprise a pivot axis which may be substantially horizontal in use. The ramp member may typically extend outboard of the hull and/or in may extend from the hull downward beyond an underside or keel of the hull.

Upon advancing the vessel across the water, e.g. through movement of the vessel in one direction, e.g. a forward or rearward direction, water may pass or be urged through the aperture or gap of ramp structure in an opposite direction, e.g. rearward or forward direction.

According to a sixth aspect of the invention, there is provided a method of launching or recovering an underwater unit from a surface vessel, the method comprising the steps of: providing a surface vessel according to the fifth aspect of the invention on the water, whereby the ramp structure in the operational position is provided under the water; lowering or moving the ramp member with respect to the hull into the operational position; advancing the vessel across the water, obtaining a flow of water relative to the vessel in the aperture or gap through the underwater ramp structure; supporting the underwater unit on the ramp structure, moving the underwater unit up or down the incline of the ramp member to facilitate in the launch or recovery of the underwater unit.

The method may include using water passing rearward relative to the hull to impart a component of force against the underwater unit on the ramp structure, through the aperture or gap of the ramp structure. The vessel may extend in a longitudinal direction between a forward end, e.g. bow, and a rearward end, e.g. aft, and the underwater unit may thus be moved in the longitudinal direction up or down the ramp.

Various embodiments of the invention may be advantageous in various ways as will be apparent from throughout herein. By way of the ramp member comprising a structure with one or more gaps or apertures water may be let through the ramp member inclined in the water during forward motion of the surface vessel to facilitate retrieval of an underwater unit, such as an ROV or AUV or the like. The motion of the water rearward relative to the surface vessel and through the one or more gaps or apertures may impart lift forces to the underwater unit when over the ramp. The lift forces may reduce the friction between the underwater unit and the ramp facilitating the launch or recovery of the underwater unit. Furthermore, drag forces imparted to the underwater unit, by the vessel dragging the underwater unit horizontally through the water and/or letting water pass through the one or more gaps or apertures, can advantageously provide passive dampening and tensioning effects on the tether or umbilical between the vessel and the underwater unit, which may help to avoid or reduce the chances of undesirable snap loads on the tether/umbilical, particularly in a chaotic or heavy sea environment. By way of the imparted drag forces, control of the relative position of the underwater unit and the vessel along a horizontal direction may be facilitated and/or relative movements between vessel and the underwater unit during launch/recover may be reduced or minimized. Further, wave effects and drag on the ramp may be limited through structure of the ramp and permitting water rearward through the aperture.

Any of the above aspects of the invention may have further feature as set out in relation to any other aspect of the invention wherever described herein. Any feature specified in relation to the unmanned surface vessel may be a further feature in relation to the surface vessel, which potentially may be manned.

### DRAWINGS AND DESCRIPTION

There will now be described, by way of example only, embodiments of the invention with reference to the accompanying drawings, in which:

FIG. 1 is a representation of an unmanned surface vessel (USV) during recovery of a remotely operated underwater vehicle (ROV); and

FIGS. 2A to 2D are perspective representations of different ramp variants for the USV of FIG. 1 for use in recovering or launching the ROV.

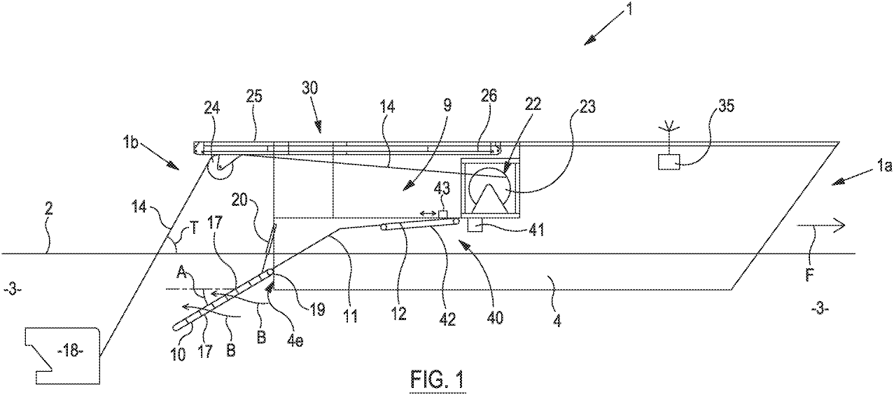

Referring firstly to FIG. 1, there is generally depicted an unmanned surface vessel (USV) 1 at the sea surface 2. The unmanned surface vessel 1 is arranged to launch and recover an underwater vehicle, which in this example is a remotely operated underwater vehicle (ROV) 18. The launch and recovery of the ROV 18 is carried out under remote control, e.g. from a control room on land, or under automated control, e.g. preprogrammed.

In FIG. 1, the ROV 18 is located below the sea surface 2, in the sea 3. The vessel 1 has a hinged ramp member 10 which is submerged in the sea providing a ramp structure having an incline for the ROV. The ROV 18 is tethered and coupled to the USV by a tether 14.

To recover the ROV 18, the tether 14 is used to pull the ROV 18 up the incline of the submerged ramp member 10 and bring it onboard the surface vessel 1. Conversely, to launch the ROV 18, the ROV is to travel down the incline of the ramp member 10 and into the sea 3.

The recovery and launch of the ROV 18 is performed during movement of the surface vessel 1 slowly forward, i.e. in the direction as indicated by arrow F. One or more propulsion devices (not shown) of the vessel 1 are operated to produce the appropriate forward motion.

The ramp member 10 has one or more apertures 17 for letting through seawater, in the flow direction indicated by arrows B, as the surface vessel 1 travels forward through the sea. Examples of the ramp member 10 are described in further detail below. The apertures 17 in the ramp member 10 can facilitate the stability of the ramp structure in rough sea, which in turn may allow vessel speeds allowing tension on the tether to be controlled, e.g. with variations within acceptable limits.

The water passing rearward along the vessel as indicated by arrows B also act through the apertures 17 against an underside of the ROV 18 when the ROV 18 is supported on the ramp member 10, and at sufficient speeds, can produce a vertical component of force against the ROV which may impart lift to the ROV 18. This may reduce the load or tension, or variations thereof, to which the tether 14 is subjected during the recovery or launch. This in turn can help to control the tension of the tether 14, in particular in rough sea states.

The ramp member 10 is in this example hinge-wise coupled to a rear end part of a hull 4 of the vessel via a pivot 19 on the hull 4. The ramp member 10 is rotatable about the pivot 19 from an upright position to a lowered, operational position in which the ramp member 10 is located, in this case fully submerged as shown in FIG. 1, in the sea 3 for facilitating the launch or recovery of the ROV. The ramp member 10 can be lowered when the vessel 1 is stationary or moving.

The ramp member 10 is moved to and arranged in the upright, stowed position when the ROV 18 is onboard and stored in a storage region 9 of the vessel 1. The vessel 1 with the ROV onboard may then transit to another site with the ramp member 10 in the upright position. This can be convenient for removing the ramp from the water so that it does not create drag or interfere below the hull when not required, e.g. during transit. The ramp member 10 in the upright position provides a rear fence for the ROV which may act a safety barrier.

Further, the ramp member 10 can also be arranged in upright, stowed position whilst the ROV is deployed in the water and performing a work operation underwater. In the course of an ROV work operation and whilst the ROV is deployed, the vessel 1 can then potentially move to other locations on the surface of the sea 3, e.g. according to a predetermined schedule or plan with the ramp raised in the stowed position.

At least one linear actuator 20, e.g. hydraulic or electrically operable, is arranged and operable to vary in length between a rear end part of the hull 4 and the ramp member 10 for lowering or raising the ramp member 10. Thus, by operating the actuators 20 the ramp 10 can be lowered. In addition, the amount of incline of the ramp member 10 in the water can be varied, by operation of the actuator 20. Accordingly, the angle of incline A of the ramp with respect to the water line 2 can be varied, and the ramp member 10 may be positioned with a predefined and/or desired incline angle A, for example dependent upon parameters such as sea conditions and/or vessel speed and/or tension and/or weight of ROV etc. Setting the incline angle A of the ramp member 10 appropriately may facilitate obtaining the proper conditions and/or control of tension and lift upon the ROV 18 (by water flowing through the one or more apertures 17) during the launch or recovery.

Apparatus 30 of the vessel 1 for launching and recovering the ROV 18, in addition to the ramp member 10, includes means for paying out the tether 14 from the surface vessel 1 for deployment of the ROV 18 and pulling in the tether 14 for recovery of the ROV 18. To this end, the launch and recovery apparatus 30 includes a winch 22 including a storage reel 23 for storing the tether 14, and a guide member in the form of a sheave 24. In FIG. 1, a length of the tether 14 is payed out from the reel 23. The tether 14 extends from the reel and passes via the sheave 24 to the underwater ROV 18.

The sheave 24 is mounted on frame 25 which in turn is coupled to a guide rail 26 which extends along the vessel 1. The frame 25 is operable to travel horizontally in forward or rearward direction on the rail 26. In this way, the sheave 24 can be positioned in suitable positions along the vessel for supporting the tether 14.

The tether 14 passes over a point on the sheave 24 higher than the departure point from the winch 23 and greater than the height of the ROV when onboard the vessel 1 in the storage region. In this case, the frame 25 together with the sheave 24 is moved rearward and protrudes over the sea surface 2 from a rear end of the hull. Furthermore, in the position indicated in FIG. 1, the sheave 24 is arranged, in air, vertically above the submerged and inclined ramp member 10 in the sea 3. By moving the frame 25 forward or backward along the rail 26, the pull angle or angle of attack of the tether 14 upon the ROV can be adjusted. This adjustment of the position of the sheave 24 can help adjust the pull-angle / angle of attack of the umbilical upon the ROV 18, while winch is the main component in addition to the forward movement of the vessel in maintaining tension on the tether. The position of the sheave 24 may be adjusted to take account of and/or in response to heave, roll, or pitch motions of the vessel, also during the movement of the vessel forward during deployment and recovery.

The tether 14 departs from the sheave 24 to the ROV 18 with suitable angle of attack T relative to the water line for facilitating to recover the ROV. The tether 14 is arranged so as to impart and/or maintain a lifting force component upward on the ROV. The position of the sheave 24 and consequently the angle of attack T may be selected depending also upon the angle of the ramp member 10.

In the example of FIG. 1, two onboard slope sections 11, 12, are provided for further facilitating the recovery and launch of the ROV 18. The ramp member 10 is hinged at the pivot 19 and lowered relative to the slope section 11, 12 into the position of FIG. 1. The ramp member 10 is inclined, so as to have the same angle of inclination A as a surface of the first slope deck section, although this may not necessarily need to be the case. A surface of the second onboard slope section 12 has shallower angle of incline than the first slope section. The ROV 18 is supported upon the second slope section and is held at rest in the storage region 9 when it is recovered or otherwise stored onboard the surface vessel 1. The tether 14 is wound onto the reel 23 and through its connection to the ROV 18 holds the ROV 18 in position on the on the second slope section 12, e.g. in the storage position, and may hinder or restrict slippage of the ROV 18 back down the slope. It can be appreciated that the ramp member 10 together with the first and second onboard slope sections 11, 12 provide a slipway for launching and submerging the ROV 18 in the water. Indeed, therefore in the case of launching, the releasing the tension on the tether 14 allows the ROV 18 to slip down one or more of the onboard sloped sections and ramp, under the force of gravity.

In the example of FIG. 1, the vessel 1 includes positioner means 40 for positioning the ROV when onboard the vessel. The positioner means 40 can operate to controllably establish and/or maintain tension on the tether 14 for facilitating launch of the ROV 18. To this end, the positioner means 40 has a mechanism onboard the vessel 1 for urging the ROV 18 out of the storage position. More specifically, the positioner means 40 in this example has a belt 42 provided with a “kicker” 43 in the form of a centred “knee plate” that is moved on the belt 42 down the inboard ramp 12 on the aft of the vessel 1. The belt 42 is rotatable and arranged to be driven (so as to rotate) by a motor 41, e.g. a hydraulic or electric motor. The belt 42 extends longitudinally along the vessel downslope, e.g. following the incline of the inboard sloped section 12. When being driven, the belt 42 section to engage the ROV 18 moves in the longitudinal direction toward the aft end 1b of the vessel. The kicker 43 is configured to engage the ROV so that upon rotation of the belt 42 the kicker 43 is urged against and exerts a force against the ROV 18 toward the rear end 1b of the vessel. Since the ROV 18 is coupled to the tether 14 which in turn is coupled to the winch 23, the tether / umbilical cable 14 is tensioned and/or slack is taken up as the ROV is moved and/or urged rearward with assistance of the belt and kicker. This can facilitate trying to ensure that the correct tension is at all times maintained during the launch and/or recovery of the ROV and/or that snap loading does not occur, noting that loads and conditions may vary as the ROV 18 is move from stationary and then over ramp sections with different angles of incline.

Alternatively, the same or similar functionality could be achieved by the positioner means instead comprising an arm or other member on the frame 25, e.g. gantry, for pushing and/or urging the ROV away from the storage position 9 by running the gantry with sheave 24 toward the aft end 1b of the vessel 1 during launch of the ROV. Alternatively, a separate pusher e.g. arm, that is operated by an actuator to produce movement that imparts a force against the ROV may be provided to push the ROV 18 out of the storage position, e.g. without or in addition to utilising the movement rearward of the gantry assembly as a whole along the rail.

By use of such positioner means 40, friction of the ROV 18 against the sloped deck section 12 in the storage position may be overcome and initiation of movement of the ROV 18 out of the storage region 9 and down the slipway may be facilitated. The sheave 24 and frame 25 are simultaneously moved toward the rear 1b during launch, and may take at least some of the load/weight of the ROV 18.

The tether 14 in this example is an umbilical cable providing the ROV 18 with data, power, and/or fluid communication services. Instructions for operating the ROV 18 are communicated through the umbilical cable. The umbilical cable is permanently connected to the ROV throughout the deployment and use of the ROV 18 during underwater ROV operations. As can be appreciated, the ROV 18 is thus recovered by means of the umbilical cable, and the umbilical cable 14 may thus be reinforced structurally for allowing winding in and paying out for launch and recovery purposes, as well as for the umbilical communications purposes. In other variants however, the tether 14 for launch and recovery does not provide such communications services. A separate or additional umbilical cable, e.g., power, data, and /or fluids can then be provided in some variants for delivery of communications.

In another variant, a tether management system (TMS) may be connected to the ROV 18. The TMS would then be locked onto the ROV 18 during launch & recovery and unlocked at depth. The TMS includes an internal spool arranged to spool out neutrally buoyant cable.

The onboard sloped sections 11, 12 are in this example fixed position sections which do not hinge. In other variants however, one or more onboard sloped sections 11, 12 may comprise a hinged ramp or ramp section that can be lowered or raised e.g. to suitable angles, e.g. using actuators or the like.

It can be noted that the two onboard sloped sections 11, 12 in this example may be combined as one. Furthermore, the one or more onboard sloped sections 11, 12 can provide an onboard ramp or slipway that is curved in the longitudinal direction providing smooth or gradual transitions where the slope of the ramp or slipway changes gradually with length, e.g. convex ramp with monotonically shallowing angle of inclination toward the storage region 9. Alternatively, the onboard ramp can be planar with constant slope.

In other variants, the vessel 1 may include one or more hinged ramp members. Instead of a hinged ramp 10, the ramp member 10 may be provided and lowered into the sea in another way for example extended or from a slot in the vessel or by other manner.

As can be seen, the hinged ramp 10 protrudes rearward into the sea outboard from a rear end part 4e of the hull 4 of the vessel 1.

The ramp member 10 is operated by the actuators 20, which in turn may be operated through vessel control system 35. The positioning of the frame 25 and sheave 24 may also be operated by commands communicated from the control system. Data comprising e.g. commands or instructions, are transmitted to operate a motor or actuator for driving the movement of the frame 25 along the rail 26. The vessel control system 35 may be operated by remote control from shore, locally onboard vessel or according to pre-programmed instructions.

In use, the surface vessel 1 transits to a site with the ROV 18 onboard. To launch the ROV, the ramp member 10 is lowered into the sea 3 to an operational position in which the ramp member 10 is inclined and submerged in the sea 3. The vessel 1 moves steadily forward through the water. The ROV is urged down the slipway including the onboard slope sections 11, 12 and the submerged ramp member 10. Water passing rearward along the hull passes through the apertures and through the apertures also imparts a force against the ROV facilitating its launch. The tether 14 is paid out and the ROV is supported on the winch via the sheave 24 while simultaneously the ROV is supported on the ramp member 10. Once underwater the ROV is used for operations. To recover the ROV, the tether is pulled in bringing the ROV up the ramp member 10, while the vessel 1 is moving forward, and onboard to the storage region 9 in the surface vessel 1.

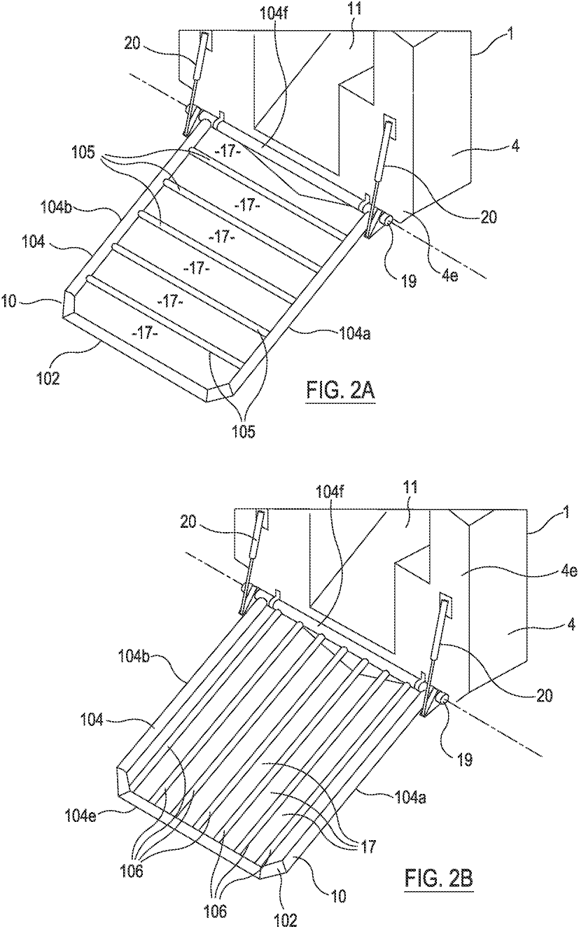

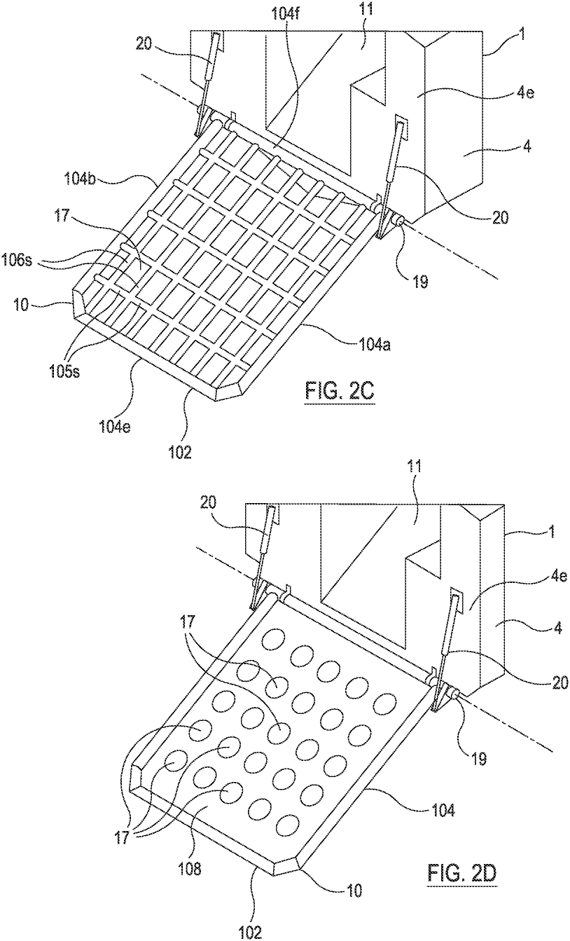

Turning to FIGS. 2A to 2D, various examples of the ramp member 10 are depicted. In FIG. 2A, the ramp member 10 has two side rails 104a, 104b extending in the direction of incline, and several transverse bars 105 extending in a direction transverse to the direction of incline between the side rail 104a on one side and the side rail 104b on the other, opposite side of the ramp 10. The transverse bars 105 are spaced apart, in this example, at regular intervals along the side rails 104a, 104b to define apertures 17 through the ramp 10 between respective adjacent pairs of transverse bars. The ramp member 10 generally comprises a rectangular frame 102 which is elongate in the ramp incline direction. The side rails 104a, 104b thus extend in parallel in the longitudinal direction.

In FIG. 2B, the ramp member 10 is provided with longitudinal bars 106 instead of the transverse bars 105. The longitudinal bars 106 extend in the direction of incline between a first end bar 104e and a second end bar 104f of outer frame 104. The first and second end bars 104e, 104f both extend in a direction transverse to the direction of incline. The longitudinal bars 106 in this example extend in parallel and are spaced apart from one another at regular distances in the transverse direction. In this way, apertures 17 through the ramp member 10 are defined between adjacent pairs of the longitudinally running bars 106. The end bar 104f is supported on a support and arranged to pivot to provide the hinged coupling and movement, e.g. lowering or raising, of the ramp member 10.

In FIG. 2C, the ramp member 10 is provided with a lattice of bar sections running longitudinally and bar sections running longitudinally. Individual apertures are defined respectively between two adjacent transverse bar sections and two adjacent longitudinal bar sections.

In FIGS. 2A to 2C, the apertures are rectangular, although in other examples have other forms.

In FIG. 2D, the ramp member 10 is provided in the form of a panel 108 within an outer frame 104. Apertures 17 through the ramp member 10 are in the form of circular holes 17 that penetrate through the panel 108.

The ramp member 10 in the various examples described herein is preferably a stiff rigid structure, which facilitates deployment and use on an unmanned surface vessel. The ramp member 10 in these examples comprises typically metal, e.g. aluminium, steel or the like, e.g. stainless steel. In principle however, any suitable material may be used, selected from any of plastics material, synthetic materials, composite materials, e.g. high-performance composite materials, e.g. carbon fibre composites, etc.

Furthermore, the ramp members 10 as described are merely examples and provide constant or uniform slope in the water for the ROV. Alternatives include one or more ramp members configured to provide a curved ramp structure which extends on a curved trajectory in a curvature direction and between first and second sides in a direction transverse to the curvature direction. In such an alternative, the ramp member is arranged so as to be supported in the water so that the ROV during launch or recovery is inclined on one part of the ramp structure more steeply than on another part. The angle of the incline of the ramp structure thus increases or reduces, e.g. monotonically increasing or decreasing, in the curvature direction.

As can be appreciated, the different arrangements of the ramp member 10 in the examples of FIGS. 2A to 2D can give rise to different drag and/or lift characteristics in the water. Configurations using bars, e.g. smooth cylindrical rods, may produce less drag due to hydrodynamic shape. Closer spacing of bars such as in FIGS. 2C or 2D, as compared to FIG. 2B, can increase the surface area into total exposed to the water, which may increase drag. The panel of FIG. 2D has a planar surface portions which is acted upon by the sea upon forward motion of the vessel 1 to use the sea motion to facilitate support of the ROV 18 and channeling of fluid through the holes to produce low friction slip surface on the top of the panel surface for the ROV 18. Larger apertures such as in FIGS. 2A or 2B can facilitate direct lift forces against the ROV structure by fluid flow B through the aperture 17, yet can provide a low resistance structure in the water that can be relatively unaffected by high sea states.

As can be noted in the above, the underwater vehicle is released down the incline of the ramp structure while the vessel is in forward motion through water (or stationary if weather permits). This can be advantageous, as the underwater vehicle is gradually submerged in water the tension on the umbilical to the underwater vehicle remains high due to drag through water. This can prevent unwanted motion in the underwater vehicle that could destroy the umbilical, vehicle, vessel or other equipment. CT mode (Constant Tension functionality) on the umbilical winch can help to further avoid loss of tension on umbilical between USV and ROV. Loss of tension, also called “snap loads” are undesirable events that may impart damage to umbilical, ROV, LARS, sheave wheels, winch system or other connection points of umbilical. The overhead sheave wheel system is constructed to be able to move aft/forward as required for adjusting the lift point and umbilical angle of attack. This can allow for finding the optimal pull and lift forces on the ROV during launch and recovery, resulting in minimal impact loads seen between ROV and USV ramp.

Although an unmanned surface vessel 1 is described above, the ramp member 10 could also be employed in the same or similar manner on other types of vessel for launching or recovering an underwater vehicle. Typically, it may be used on vessels both manned or unmanned of up to 50 m in length.

In other examples, other underwater vehicles may be deployed, e.g. an autonomous underwater vehicle (AUV) may be deployed using the ramp member 10. In such an example, the AUV may be coupled to a launch or recovery tether for purposes of launch and recovery via the ramp 10, but where otherwise during work operations the tether is detached and operable under own motive power and instructions with no cable coupled to it.

Furthermore, the ramp member 10 may alternatively be used for deployment and recovery of a multitude of different tethered underwater units such as instruments, equipment, or machines instead of or in addition to the underwater vehicles such as ROVs as described herein.

The various examples can be advantageous in recovering highly sophisticated and complex underwater vehicles to a surface vessel in a simplified and robust method compared with prior art solutions. Forward motion through water can advantageously be used to act as a damping force on the underwater vehicle when being pulled up/into the ramp or pushed down/out the ramp, preventing also the vehicle from damage and snap load scenarios during launch and recovery.

By way of the present solution, the relative movement between the underwater vehicle and the surface vessel may be minimized without having to use any active dampening devices to allow for use of a small surface vessel (<50 m) as mothership for an underwater vehicle.

Furthermore, the ramp member may be deployed and/or lowered to the operational position in other ways, e.g. by sliding down a track from the hull or extracting from a slot in the hull or any other suitable manner.

Various modifications and improvements may be made without departing from the scope of the invention herein described.

1-27. (canceled)

28. An unmanned surface vessel for use on water, the unmanned surface vessel having a hull and at least one ramp member for providing a ramp structure under the water for facilitating launch or recovery of an underwater unit, the ramp structure comprising an incline for moving the underwater unit up or down the incline, and at least one aperture or gap penetrating through the ramp structure for communicating a flow of water in the aperture or gap relative to the unmanned surface vessel, the ramp member being movable with respect to the hull to obtain an operational position in which the ramp member is arranged to provide the ramp structure in use, the unmanned surface vessel further comprising at least one actuator between the hull and the ramp member for moving the ramp member into the operational position with respect to the hull.

29. The unmanned surface vessel as claimed in claim 28, wherein the ramp member is movably coupled to the hull so as to be hingeable about a pivot on the hull.

30. The unmanned surface vessel as claimed in claim 28, wherein vessel has a hull and the ramp member is arranged to protrude outboard from the hull.

31. The unmanned surface vessel as claimed in claim 28, wherein the unmanned surface vessel has a hull and the ramp member is arranged to have an extent underwater in use to provide the ramp structure, the ramp member extending to a depth underwater that is lower than an underside of the hull.

32. The unmanned surface vessel as claimed in claim 28, further comprising at least one sloped deck section, wherein the ramp member together with the sloped deck section provides a slipway for the underwater unit.

33. The unmanned surface vessel as claimed in claim 28, further comprising launch and recovery apparatus comprising any one or more of:
the ramp member;
a winch;
a tether extending between the winch and the underwater unit; and
a sheave through which the tether is passed between the winch and the underwater unit, the sheave arranged to be moved forward or rearward along the unmanned surface vessel for positioning the sheave relative to the ramp member and/or the underwater unit.

34. The unmanned surface vessel as claimed in claim 28, wherein the underwater unit is an underwater vehicle.

35. The unmanned surface vessel as claimed in claim 34, wherein the underwater vehicle is either a remotely operated underwater vehicle, ROV, or an autonomous underwater vehicle, AUV.

36. A method of launching or recovering an underwater unit from an unmanned surface vessel, the method comprising the steps of:
providing an unmanned surface vessel on water, whereby a ramp structure is provided under the water;
advancing the unmanned surface vessel across the water, obtaining a flow of water relative to the unmanned surface vessel in an aperture or gap through the ramp structure; and
supporting the underwater unit on an incline of the ramp structure, moving the underwater unit up or down the incline to facilitate in the launch or recovery of the underwater unit.

37. The method as claimed in claim 36, which further comprises providing launch and recovery apparatus which includes:
at least one winch provided with at least one tether extending between the winch and the underwater unit;
at least one sheave through which the tether passes and which is movably positioned rearward or forward along the unmanned surface vessel relative to the ramp structure;
at least one actuator to lower the ramp structure to incline and submerge the ramp structure in the water;
operating the launch and recovery apparatus to determine control tension of the tether.

38. The method as claimed in claim 37, wherein said operating step includes positioning the sheave to determine an angle of attack between the underwater unit and the sheave and positioning the ramp structure using the actuator to determine an angle of incline of the ramp structure.

39. The method as claimed in claim 36, which further comprises pulling the underwater unit up the incline of the ramp structure to bring the underwater unit onboard to recover the underwater unit or letting the underwater unit travel down the incline of the ramp structure to launch the underwater unit into the water.

40. A ramp member for an unmanned surface vessel for use on water, the unmanned surface vessel having a hull and at least one ramp member for providing a ramp structure under the water for facilitating launch or recovery of an underwater unit, the ramp structure comprising an incline for moving the underwater unit up or down the incline, and at least one aperture or gap penetrating through the ramp structure for communicating a flow of water in the aperture or gap relative to the unmanned surface vessel, the ramp member being movable with respect to the hull to obtain an operational position in which the ramp member is arranged to provide the ramp structure in use, the unmanned surface vessel further comprising at least one actuator between the hull and the ramp member for moving the ramp member into the operational position with respect to the hull.

41. The ramp member as claimed in claim 40, comprising a structure that is rigid, the structure comprising at least one aperture or gap therethrough.

42. The ramp member as claimed in any of claim 41, wherein the structure comprises a frame comprising at least one pair of parallel bars or parallel bar sections extending in a first direction and having at least one aperture between one parallel bar of the pair of parallel bars and another parallel bar of the pair of parallel bars.

43. The ramp member as claimed in claim 42, wherein the structure comprises a frame comprising at least one pair of parallel bars extending in a second direction, transverse to the first direction, and having at least one aperture between one parallel bar of the pair of parallel bars and another parallel bar of the pair of parallel bars.

44. The ramp member as claimed in claim 43, wherein the structure comprises a panel, and apertures comprising holes through the panel.

45. A launch and recovery apparatus for a surface vessel on water, the apparatus comprising at least one ramp member for providing a ramp structure under the water for facilitating launch or recovery of an underwater unit from the surface vessel, the ramp structure comprising an incline for the underwater unit and at least one aperture or gap penetrating through the ramp structure for communicating a flow of water in the aperture or gap relative to the unmanned surface vessel.
